(19) United States
(12) Patent Application Publication
(10) Pub. No.: US 2015/0278215 A1
(43) Pub. Date: Oct. 1, 2015

(54) TERMINAL AND SOCIAL GROUP CONFIGURING METHOD THEREOF, AND COMMUNICATION SYSTEM INCLUDING THE TERMINAL

(71) Applicant: Electronics and Telecommunications Research Institute, Daejeon (KR)

(72) Inventor: Jae Ho LEE, Daejeon (KR)

(21) Appl. No.: 14/475,990

(22) Filed: Sep. 3, 2014

(30) Foreign Application Priority Data
Mar. 27, 2014 (KR) 10-2014-0035733

(51) Int. Cl. G06F 17/30; H04L 12/911; H04L 12/18

(52) U.S. Cl. CPC G06F 17/3053; H04L 12/1813; H04L 47/70

(57) ABSTRACT

Disclosed is a terminal including: a social group creating unit which creates a social group on a social network service; a communication unit which transmits a search message to target terminals, configures communication connection with the target terminal by receiving a search response message which corresponds to the search message and includes a target social identifier from the target terminals, transmits an invitation message including a source social identifier and an access code to at least one target terminal which transmits the search response message among the target terminals, and receives an invitation response message corresponding to the invitation message from at least one target terminal; and a control unit which adds at least one target terminal to the social group based on the invitation response message.

### CROSS-REFERENCE TO RELATED APPLICATIONS

This application claims priority to and the benefit of Korean Patent Application No. 10-2014-0035733 filed in the Korean Intellectual Property Office on Mar. 27, 2014, the entire contents of which are incorporated herein by reference.

### TECHNICAL FIELD

The present invention relates to a terminal and a social group configuring method thereof, and a communication system including the terminal.

### BACKGROUND ART

With the development of Internet communications, various social network services (SNSs) have emerged and the number of subscribers to each social network service has also explosively increased. The subscribers form various human networks with other subscribers through the social network service. However, it is difficult to form networking among users who subscribe to different social network services due to a lack in interoperability among the social network services.

Meanwhile, with activation of the distribution of mobile terminals (a smart phone, a smart pad, and the like), there are many cases in which most users use the social network service while moving. In particular, there have been increased demands for attempting networking such as data sharing, conversations, games, and the like by forming a social group with different users based on the position of the users while moving.

### SUMMARY OF THE INVENTION

The present invention has been made in an effort to provide a terminal and a social group configuring method thereof, and a communication system including the terminal that can provide a social networking service among users who subscribe to different social network services.

The objects of the present invention are not limited to the aforementioned objects, and other objects, which are not mentioned above, will be apparent to those skilled in the art from the following description.

An exemplary embodiment of the present invention provides a terminal including: a social group creating unit which creates a social group on a social network service; a communication unit which transmits a search message to target terminals, configures communication connection with the target terminals by receiving a search response message which corresponds to the search message and includes a target social identifier from the target terminals, transmits an invitation message including a source social identifier and an access code to at least one target terminal which transmits the search response message among the target terminals, and receives an invitation response message corresponding to the invitation message from at least one target terminal; and a control unit which adds at least one target terminal to the social group based on the invitation response message.

The search message may be a management frame used for device-to-device communication.

The target social identifier may include at least one of an e-mail address, a phone number, and a subscription ID of the social network service of a user of the target terminal.

The terminal may further include a storage unit which stores an identifier database.

The communication unit may compare the target social identifier with the identifier database and when the target social identifier exists in the identifier database, the communication unit transmits the invitation message to at least one target terminal.

The control unit may add at least one target terminal to the social group when the invitation response message indicates invitation acceptance.

The communication unit may communicate with the server to register the social group in the server.

Another exemplary embodiment of the present invention provides a social group configuring method of a terminal, including: creating a social group on a social network service; transmitting a search message to target terminals; receiving a search response message corresponding to the search message and including a target social identifier from the target terminals; transmitting an invitation message including a source social identifier and an access code to at least one target terminal which transmits the search response message among the target terminals; receiving the invitation response message from at least one target terminal; and adding at least one target terminal to the social group based on the invitation response message.

The target social identifier may include at least one of an e-mail address, a phone number, and a subscription ID of the social network service of a user of the target terminal.

The method may further include comparing the target social identifier with an identifier database.

In the transmitting of the invitation message including the source social identifier and the access code to at least one target terminal which transmits the search response message among the target terminals, when the target social identifier exists in the identifier database, the invitation message may be transmitted to at least one target terminal.

In the adding of at least one target terminal to the social group based on the invitation response message, when the invitation response message indicates invitation acceptance, at least one target terminal is added to the social group.

The method may further include: registering the created social group in a server; and receiving a registration identifier for the social group from the server.

Yet another exemplary embodiment of the present invention provides a terminal including: a communication unit which transmits a search response message including a target social identifier to a source terminal in response to a search message received from the source terminal and transmits a social group invitation response message to the source terminal in response to a social group invitation message received from the source terminal; and a control unit which compares a source social identifier included in the social group invitation message with an identifier database to determine whether to transmit the social group invitation response message.

The source social identifier may include at least one of an e-mail address, a phone number, and an ID of the social network service of a user of the source terminal.

The control unit may control the communication unit to transmit the social group invitation response message when the source social identifier exists in the identifier database.

The social group invitation message may include an access code for accessing the social group, and the control unit may output the access code so as for the user to verify the access code.

Still another exemplary embodiment of the present invention provides a communication system including: target terminals; and a source terminal which creates a social group on a social network service, transmits a search message to the target terminals, configures communication connection with the target terminals by receiving a search response message which corresponds to the search message and includes a target social identifier from the target terminals, transmits an invitation message including a source social identifier and an access code to at least one target terminal which transmits the search response message among the target terminals, and receives an invitation response message corresponding to the invitation message from at least one target terminal and adds one or more target terminals to the social group based on the invitation response message.

The source terminal and one or more target terminals added to the social group may communicate with each other through the social network service.

The source terminal may register in the created social group in a server and receives a registration identifier from the server.

According to exemplary embodiments of the present invention, a terminal and a social group configuring method thereof, and a communication system including the terminal can provide a social network service by configuring a social group among users of terminals using different social network services.

According to the exemplary embodiments of the present invention, the terminal and the social group configuring method thereof, and the communication system including the terminal can provide the social network service by configuring terminals that do not log in a server providing the social network service as the social group.

According to the exemplary embodiments of the present invention, the terminal and the social group configuring method thereof, and the communication system including the terminal can decrease a load of the server by providing the social network service among terminals by using device-to-device (D2D) communication.

### BRIEF DESCRIPTION OF THE DRAWINGS

FIG. 1 illustrates a communication system according to an exemplary embodiment of the present invention.

FIG. 2 is a diagram for describing an operation of the communication system according to the exemplary embodiment of the present invention.

FIG. 3 illustrates a communication system according to another exemplary embodiment of the present invention.

FIG. 4 is a block diagram illustrating a source terminal according to the exemplary embodiment of the present invention.

FIG. 5 is a flowchart illustrating a social group configuring method of a terminal according to an exemplary embodiment of the present invention.

FIG. 6 is a flowchart illustrating a social group configuring method of a terminal according to another exemplary embodiment of the present invention.

FIG. 7 is a flowchart illustrating a social group configuring method of a terminal according to yet another exemplary embodiment of the present invention.

FIG. 8 is a block diagram illustrating a target terminal according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, some exemplary embodiments of the present invention will be described in detail with reference to the accompanying drawings. When reference numerals refer to components of each drawing, it is to be noted that although the same components are illustrated in different drawings, the same components are referred to by the same reference numerals as possible. In describing the exemplary embodiments of the present invention, when it is determined that the detailed description of the known art related to the present invention may obscure the understanding of the present invention, the detailed description thereof will be omitted.

Terms such as first, second, A, B, (a), (b), and the like may be used in describing the components of the exemplary embodiments according to the present invention. The terms are only used to distinguish a constituent element from another constituent element, but nature or an order of the constituent element is not limited by the terms. Unless otherwise defined, all terms used herein including technological or scientific terms have the same meaning as those generally understood by a person with ordinary skill in the art to which the present invention pertains. Terms which are defined in a generally used dictionary should be interpreted to have the same meaning as the meaning in the context of the related art, and are not interpreted as an ideally or excessively formal meaning unless clearly defined in the present invention.

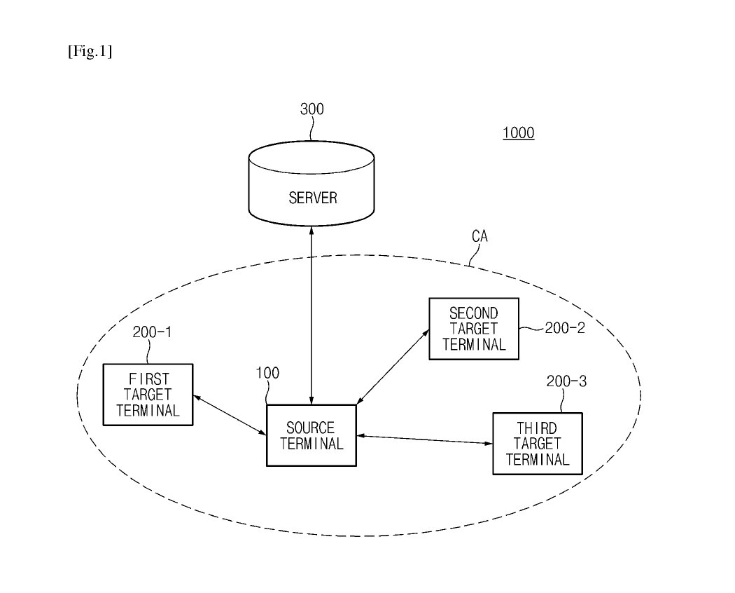

FIG. 1 illustrates a communication system according to an exemplary embodiment of the present invention.

Referring to FIG. 1, the communication system 1000 according to the exemplary embodiment of the present invention may include a source terminal 100, target terminals 200-1, 200-2, and 200-3, and a server 300.

The source terminal 100 and the target terminals 200-1, 200-2, and 200-3 described below may include a cellular phone, a smart phone having a wireless communication function, a personal digital assistant (PDA) having the wireless communication function, a wireless modem, a portable computer having the wireless communication function, a photographing device such as a digital camera having the wireless communication function, a gaming device having the wireless communication function, a music storing and reproducing home appliance having the wireless communication function, Internet home appliances capable of accessing and browsing the wireless Internet, and portable units or terminals having integrated combinations of the functions, but are not limited thereto. Hereinafter, it is assumed that the source terminal 100 and the target terminals 200-1, 200-2, and 200-3 are the smart phones for easy description.

The source terminal 100 may be a terminal capable of using a social network service (SNS) through the server 300. The source terminal 100 may create a social group on the social network service. The source terminal 100 may register the created social group in the server 300 and receive a registration identifier for the created social group from the server 300.

The source terminal 100 may configure communication connection with the target terminals 200-1, 200-2, and 200-3 by using device-to-device (D2D) communication. The source terminal 100 may configure the communication connection with the target terminals 200-1, 200-2, and 200-3 through communication functions such as, for example, WiFi P2P, and Bluetooth. For easy description, it is assumed that the target terminals 200-1, 200-2, and 200-3 are positioned in an area CA where communication among the source terminal 100 and the terminals is possible.

In detail, the source terminal 100 may transmit a search message to the target terminals 200-1, 200-2, and 200-3. For example, the search message may be defined as a management frame transmitted in a pre-association status which is a status before the communication connection is achieved between the source terminal 100 and the target terminals 200-1, 200-2, and 200-3.

The source terminal 100 may receive a search response message which corresponds to the search message and includes a target social identifier, from the target terminals 200-1, 200-2, and 200-3, respectively. The target social identifier may include at least one of an e-mail address, a phone number, and a subscription ID of the social network service of the user of each target terminal 200-1, 200-2, or 200-3. The source terminal 100 may configure the communication connection with the target terminals (for example, 200-1 and 200-2) that transmit the search response message.

The source terminal 100 may transmit an invitation message to the target terminals (for example, 200-1 and 200-2) in which the communication connection is configured. For example, the source terminal 100 may transmit the invitation message to the target terminals (for example, 200-1 and 200-2) of users having a predetermined relationship with a user of the source terminal 100 among the target terminals (for example, 200-1 and 200-2) in which the communication connection is configured.

In detail, the source terminal 100 compares the target social identifier with a prestored identifier database and when the target social identifier exists in the identifier database, the source terminal 100 may transmit the invitation message to the target terminals (for example, 200-1 and 200-2). The identifier database may include, for example, phone number data, e-mail addresses, and IDs of users having a predetermined relationship on the social network service which are stored in the source terminal 100. That is, the source terminal 100 may transmit the invitation message to only a target terminal in which the target social identifier exists in the identifier database in the target terminals (for example, 200-1 and 200-2) in which the communication connection is configured. For example, the source terminal 100 may display whether the target social identifier exists in the identifier database so as for the user to verify whether the target social identifier exists in the identifier database, and transmit the invitation message to the target terminals 200-1 and 200-2 according to selection by the user.

The invitation message may mean, for example, a message for inviting the target terminals (for example, 200-1 and 200-2) to the social group created by the source terminal 100. The invitation message may include a source social identifier and an access code. The source social identifier may include at least one of the e-mail address, the phone number, and the subscription ID of the social network service of the user of the source terminal 100. The access code may include a password for accessing the social group created by the source terminal 100.

The source terminal 100 may receive an invitation response message corresponding to the invitation message from the target terminals 200-1 and 200-2. For example, the respective target terminals 200-1 and 200-2 may transmit the invitation response message to the source terminal 100 when the users of the respective target terminals 200-1 and 200-2 and the user of the source terminal have the predetermined relationship.

In detail, the target terminals 200-1 and 200-2 compare the source social identifier with the prestored identifier database and when the source social identifier exists in the identifier database, the target terminals 200-1 and 200-2 may transmit the invitation response message to the source terminal 100. The identifier database may include, for example, phone number data, e-mail addresses, and IDs of users having a predetermined relationship on the social network service stored in the respective target terminals 200-1 and 200-2. For example, the respective target terminals 200-1 and 200-2 may display whether the source social identifier exists in the identifier database so as for the user to verify whether the source social identifier exists in the identifier database, and transmit the invitation response message to the source terminal 100 according to the selection by the user.

The source terminal 100 may add the target terminals 200-1 and 200-2 to the social group based on the invitation response message received from the target terminals 200-1 and 200-2. For example, the source terminal 100 may add the target terminals 200-1 and 200-2 to the social group when the target terminals 200-1 and 200-2 transmit the invitation response message indicating invitation acceptance. In this case, the source terminal 100 may communicate with the target terminals 200-1 and 200-2 that access the social group through the social network service.

As described above, the communication system 1000 according to the exemplary embodiment of the present invention may configure the social group of the source terminal 100 and the target terminals 200-1, 200-2, and 200-3. Accordingly, even when the users of the source terminal 100 and the target terminals 200-1, 200-2, and 200-3 use different social network services, the users may communicate with each other through the social network service. When the users of the target terminals 200-1, 200-2, and 200-3 do not log in the server that provides the social network service the users of the target terminals 200-1, 200-2, and 200-3 access the social group created by the source terminal 100 to communicate with the users of the source terminal 100 and other target terminals 200-1, 200-2, and 200-3 through the social network service.

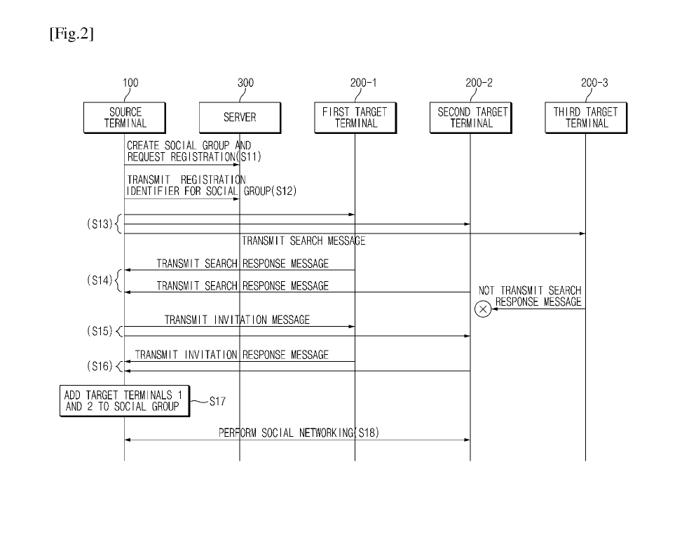

FIG. 2 is a diagram for describing an operation of the communication system according to the exemplary embodiment of the present invention. In FIG. 2, duplicated contents with contents described in FIG. 1 will be omitted for avoiding repetition.

Referring to FIG. 2, the source terminal 100 may create the social group on the social network service and make a registration request to the server 300 (S11). The server 300 may transmit a registration identifier (S12) for the social group to the source terminal 100.

The source terminal 100 may transmit the search message to a first target terminal 200-1, a second target terminal 200-2, and a third target terminal 200-3 (S13). The first target terminal 200-1 and the second target terminal 200-2 may transmit the search response message including the target social identifier to the source terminal 100 (S14). On the contrary, the third target terminal 200-3 may not transmit the search response message to the source terminal 100. The source terminal 100, and the first target terminal 200-1 and the second target terminal 200-2 may be communication-connected.

The source terminal 100 may transmit the invitation message including the source social identifier and the access code to the first target terminal 200-1 and the second target terminal 200-2 (S15). The first target terminal 200-1 and the second target terminal 200-2 may transmit the invitation response message to the source terminal 100 (S16). The source terminal 100 may add the first target terminal 200-1 and the second target terminal 200-2 to the social group (S17). Thereafter, the source terminal 100 may communicate with the first target terminal 200-1 and the second target terminal 200-2 that access the social group through the social network service.

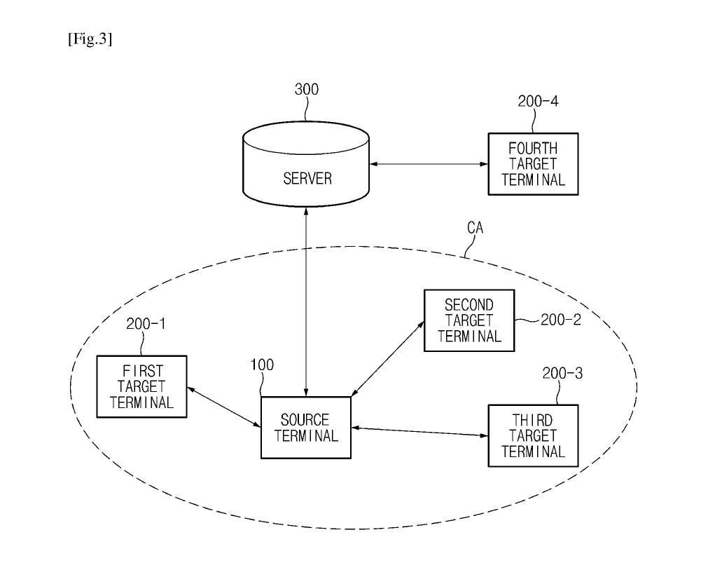

FIG. 3 illustrates a communication system according to another exemplary embodiment of the present invention.

In FIG. 3, a difference from the communication system illustrated in FIG. 1 will be primarily described.

Referring to FIG. 3, a fourth target terminal 200-4 may communicate with the server 300. For example, the fourth target terminal 200-4 may access the social group registered in the server 300 by using the registration identifier of the social group created by the source terminal 100.

That is, a user of the fourth target terminal 200-4 accesses the same social network service as the user of the source terminal 100 to search for the social group created by the source terminal 100 through the registration identifier and accesses the searched social group to communicate with the users of the source terminal 100 and other target terminals 200-1, 200-2, and 2003 through the social network service.

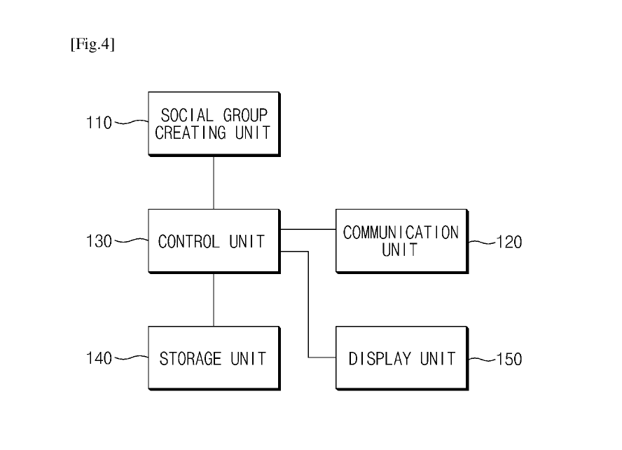

FIG. 4 is a block diagram illustrating a source terminal according to the exemplary embodiment of the present invention.

Referring to FIG. 4, the source terminal 100 according to the exemplary embodiment of the present invention may include a social group creating unit 110, a communication unit 120, a control unit 130, a storage unit 140, and a display unit 150.

The social group creating unit 110 may create the social group on the social network service.

The communication unit 120 may configure the communication connection with the target terminals 200-1, 200-2, and 200-3 by using the device-to-device (D2D) communication. The communication unit 120 may include, for example, a WiFi P2P communication module and a Bluetooth communication module. The communication unit 120 may transmit the search message to the target terminals 200-1, 200-2, and 200-3. For example, the search message may be defined as the management frame transmitted in the pre-association status which is the status before the communication connection is achieved among the source terminal 100 and the target terminals 200-1, 200-2, and 200-3.

The communication unit 120 may receive the search response message which corresponds to the search message and includes the target social identifier, from the respective target terminals 200-1, 200-2, and 200-3. The target social identifier may include at least one of the e-mail address, the phone number, and the subscription ID of the social network service of the user of each target terminal 200-1, 200-2, or 200-3.

The communication unit 120 may transmit the invitation message to the target terminals (for example, 200-1 and 200-2) that transmit the search response message. For example, the source terminal 100 may transmit the invitation message to the target terminals (for example, 200-1 and 200-2) of the users having the predetermined relationship with the user of the source terminal 100 among the target terminals (for example, 200-1 and 200-2) that transmit the search response message.

The invitation message may mean, for example, the message for inviting the target terminals (for example, 200-1 and 200-2) to the social group created by the social group creating unit 110. The invitation message may include the source social identifier and the access code. The source social identifier may include at least one of the e-mail address, the phone number, and the subscription ID of the social network service of the user of the source terminal 100. The access code may be defined as the password for accessing the social group created by the social group creating unit 110.

The communication unit 120 may receive the invitation response message corresponding to the invitation message from the target terminals (for example, 200-1 and 200-2).

The communication unit 120 communicates with the server to register the social group created by the social group creating unit 110 in the server and receive the registration identifier from the server.

The control unit 130 compares the target social identifier received from the target terminals (for example, 200-1 and 200-2) with the identifier database stored in the storage unit 140 and when the target social identifier exists in the identifier database, the control unit 130 may control the communication unit 120 to transmit the invitation message to the target terminals (for example, 200-1 and 200-2). The control unit 130 may output whether the target social identifier exists in the identifier database to the display unit 150 so as for the user to verify whether the target social identifier exists in the identifier database and control the communication unit 120 to transmit the invitation message to the target terminals 200-1 and 200-2 according to the selection by the user.

The control unit 130 may add the target terminals (for example, 200-1 and 200-2) to the social group based on the invitation response message received from the target terminals (for example, 200-1 and 200-2). For example, the control unit 130 may add the target terminals (for example, 200-1 and 200-2) to the social group when the target terminals 200-1 and 200-2 (for example, 200-1 and 200-2) transmit the invitation response message indicating invitation acceptance.

The storage unit 140 may store the identifier database. The identifier database may include, for example, the phone number data, the e-mail addresses, and the IDs of users having a predetermined relationship on the social network service.

The display unit 150 may output whether the target social identifier exists in the identifier database so as for the user to verify whether the target social identifier exists in the identifier database according to the control by the control unit 130.

As described above, the source terminal 100 according to the exemplary embodiment of the present invention may invite the target terminal 100 to the social group through device-to-device (D2D) communication. Accordingly, the user of the source terminal 100 and the user of the target terminal 200 may communicate with each other through the social network service.

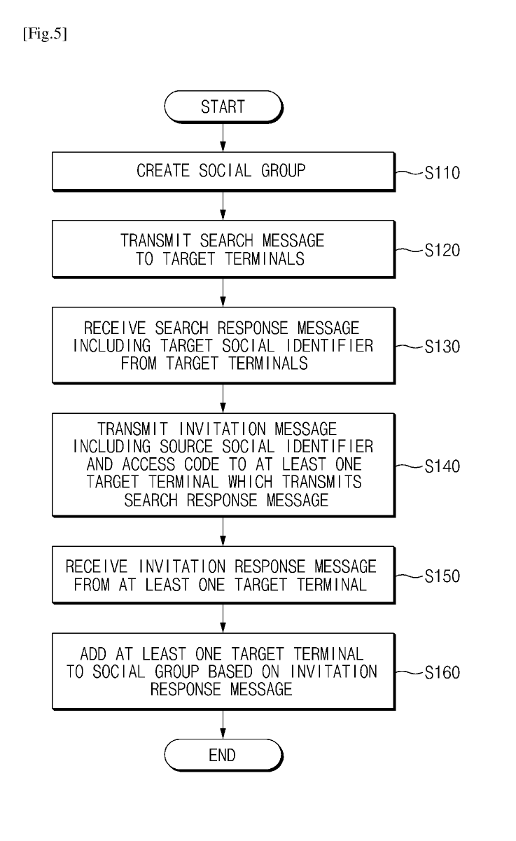

FIG. 5 is a flowchart illustrating a social group configuring method of a terminal according to an exemplary embodiment of the present invention.

Referring to FIG. 5, the social group configuring method of the terminal according to the exemplary embodiment of the present invention may include creating a social group on a social network service (S110), transmitting a search message to target terminals (S 120), receiving a search response message including a target social identifier from the target terminals (S130), transmitting an invitation message including a source social identifier and an access code to at least one target terminal which transmits the search response message (S140), receiving the invitation response message from at least one target terminal (S 150), and adding at least one target terminal to the social group based on the invitation response message (S 160).

Hereinbelow, steps S110 to S160 described above will be described in detail with reference to FIG. 4.

In step S110, the social group creating unit 110 may create the social group on the social network service.

In step S120, the communication unit 120 may transmit the search message to the target terminals 200-1, 200-2, and 200-3. For example, the search message may be defined as the management frame transmitted in the pre-association status which is the status before the communication connection is achieved among the source terminal 100 and the target terminals 200-1, 200-2, and 200-3.

In step S130, the communication unit 120 may receive the search response message including the target social identifier, from the respective target terminals 200-1, 200-2, and 200-3. For example, it is assumed that the communication unit 120 receives the search response message from only the target terminals 200-1 and 200-2.

In step S140, the communication unit 120 may transmit the invitation message including the source social identifier and the access code to one or more target terminals 200-1 ad 200-2 that transmit the search response message.

In step S150, the communication unit 120 may receive the invitation response message from one or more target terminals 200-1 and 200-2.

In step S160, the control unit 130 may add one or more target terminals 200-1 and 200-2 that receive the invitation response message to the social group.

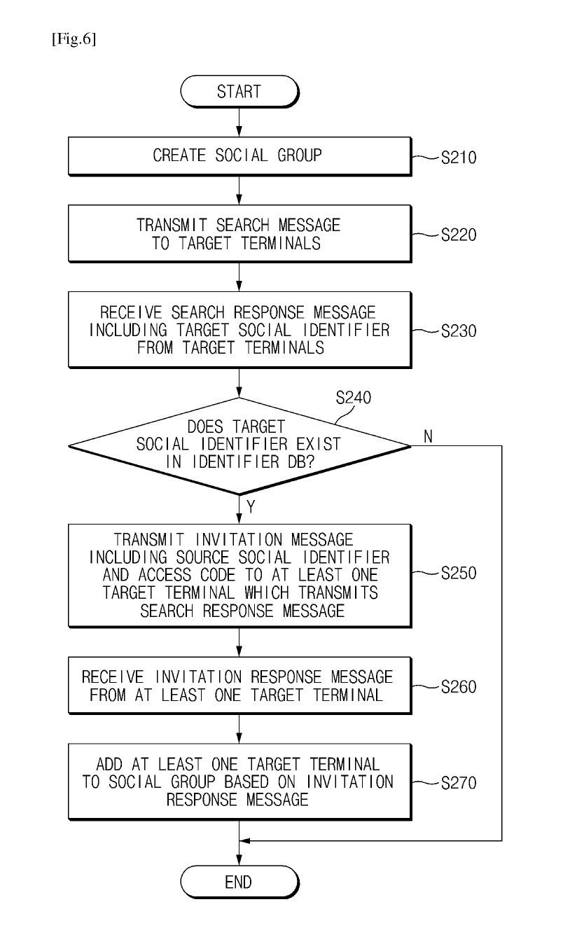

FIG. 6 is a flowchart illustrating a social group configuring method of a terminal according to another exemplary embodiment of the present invention.

In FIG. 6, a difference from the exemplary embodiment illustrated in FIG. 5 will be primarily described in order to prevent unnecessary repetition.

Referring to FIG. 6, the social group configuring method of the terminal according to another exemplary embodiment of the present invention may include creating a social group on a social network service (S210), transmitting a search message to target terminals (S220), receiving a search response message including a target social identifier from the target terminals (S230), determining whether the target social identifier exists in an identifier database (S240), transmitting an invitation message including a source social identifier and an access code to at least one target terminal which transmits the search response message (S250), receiving the invitation response message from at least one target terminal (S260), and adding at least one target terminal to the social group based on the invitation response message (S270).

Steps S210 to S230 described above may be the same as steps S110 to S130 described with reference to FIG. 5 and steps S250 to S270 may be the same as steps S140 to S160. Hereinafter, step S240 will be described in detail.

In step S240, the control unit 130 may compare the target social identifier received from the target terminals 200-1 and 200-2 with the identifier database stored in the storage unit 140. The control unit 130 may control the communication unit 120 to transmit the invitation message to the target terminals 200-1 and 200-2 when the target social identifier exists in the identifier database according to the comparison result. The control unit 130 may output whether the target social identifier exists in the identifier database so as for the user to verify whether the target social identifier exists in the identifier database to the display unit 150 and control the communication unit 120 to transmit the invitation message to the target terminals 200-1 and 200-2 according to the selection by the user. The communication unit 120 will transmit the invitation message to the target terminals 200-1 and 200-2 when the target social identifier exists in the identifier database according to the control by the control unit 130.

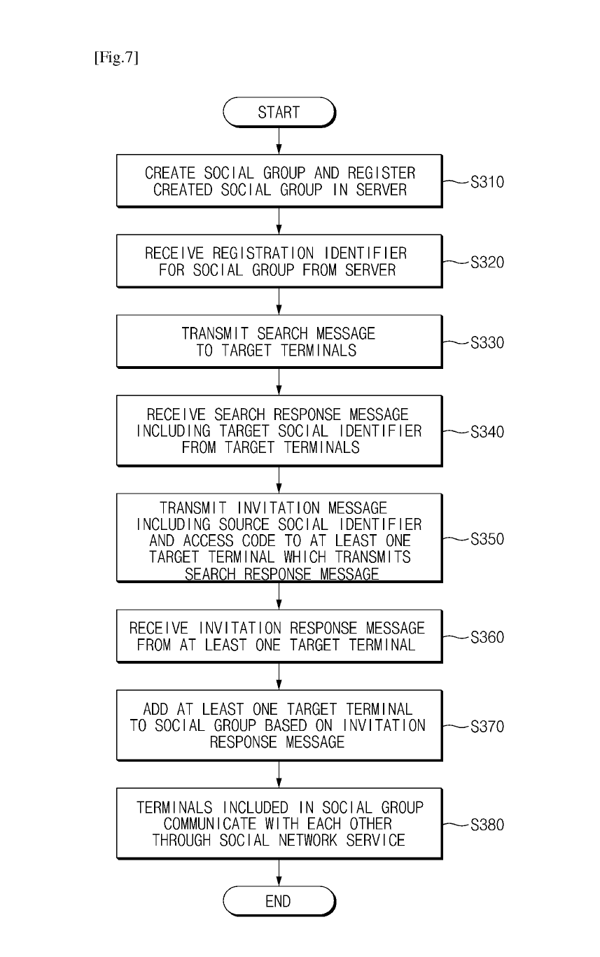

FIG. 7 is a flowchart illustrating a social group configuring method of a terminal according to yet another exemplary embodiment of the present invention.

In FIG. 7, a difference from the exemplary embodiment illustrated in FIG. 5 will be primarily described in order to prevent unnecessary repetition.

Referring to FIG. 7, the social group configuring method of the terminal according to another exemplary embodiment of the present invention may include creating a social group on a social network service and registering the created social group in a server (S310), receiving a registration identifier for the social group from the server (S320), transmitting a search message to target terminals (S330), receiving a search response message including a target social identifier from the target terminals (S340), transmitting an invitation message including a source social identifier and an access code to at least one target terminal which transmits the search response message (S350), receiving an invitation response message from at least one target terminal (S360), adding at least one target terminal to the social group based on the invitation response message (S370), and communicating, by terminals included in the social group, through the social network service (S380).

Steps S330 to S370 described above may be the same as steps S120 to S160 described with reference to FIG. 5, respectively. Hereinafter, steps S310, S320, and S380 will be described in detail.

In step S310, the social group creating unit 110 may create the social group on the social network service. The communication unit 120 may make a request for registering the created social group in the server.

In step S320, the communication unit 120 may receive the registration identifier for the social group from the server.

In step S380, the terminals included in the social group, that is, the source terminal 100 and the target terminals (for example, 200-1 and 200-2) may communicate with each other through the social network service. For example, the users of the source terminal 100 and the target terminals (for example, 200-1 and 200-2) may communicate with each other in the social group or share data.

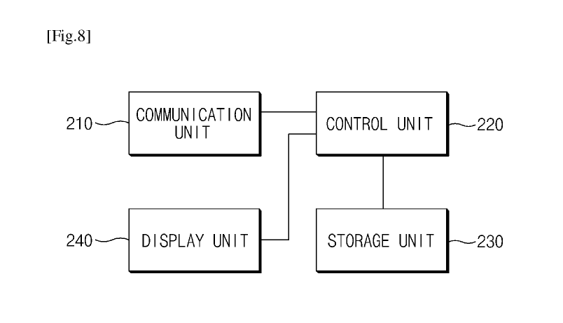

FIG. 8 is a block diagram illustrating a target terminal according to an exemplary embodiment of the present invention.

Referring to FIG. 8, the target terminal 200 according to the exemplary embodiment of the present invention may include a communication unit 210, a control unit 230, a storage unit 230, and a display unit 240.

The communication unit 210 may communicate with the source terminal 100 through the D2D communication. The communication unit 210 may receive the search message from the source terminal 100 (see FIG. 1). The communication unit 210 may transmit to the source terminal 100 the search message including the target social identifier in response to the search message. The target social identifier may include at least one of an e-mail address, a phone number, and a subscription ID of the social network service of the user of the target terminal 200. For example, the communication unit 210 may include a WiFi P2P communication module and a Bluetooth communication module. When the communication unit 210 transmits the search response message to the source terminal 100, the source terminal 100 and the target terminal 200 may be communication-connected.

The communication unit 210 may receive a social group invitation message from the source terminal 100. The social group invitation message may include the source social identifier and the access code. The source social identifier may include at least one of the e-mail address, the phone number, and the subscription ID of the social network service of the user of the source terminal 100. The access code may include a password for accessing the social group created by the source terminal 100. The communication unit 210 may transmit to the source terminal 100 the social group invitation response message in response to the social group invitation message.

The control unit 220 may control the communication unit 210 to transmit the social group invitation response message when the source social identifier exists in an identifier database stored in the storage unit 230.

The control unit 220 may output the access code through the display unit 240 so as for the user to verify the access code.

As described above, the target terminal 200 according to the exemplary embodiment of the present invention may access the social group created by the source terminal 100 through the D2D communication. Accordingly, the user of the source terminal 100 and the user of the target terminal 200 may communicate with each other through the social network service.

Therefore, steps of a method or an algorithm described in association with the exemplary embodiments disclosed in the specification may be directly implemented by hardware and software modules executed by the processor 1100, or a combination thereof. The software module may reside in storage media (that is, the memory 1300 and/or the storage 1600) such as a RAM memory, a flash memory, a ROM memory, an EPROM memory, an EEPROM memory, a register, a hard disk, a removable disk, and a CD-ROM. The exemplary storage medium is coupled to the processor 1100 and the processor 1100 may read information from the storage medium and write the information in the storage medium. As another method, the storage medium may be integrated with the processor 1100. The processor and the storage medium may reside in an application specific integrated circuit (ASIC). The ASIC may reside in a user terminal. As another method, the processor and the storage medium may reside in the user terminal as individual components.

The above description is just illustratively describe the spirit of the present invention and various changes, modifications, and variations become apparent to those skilled in the art within a scope of an essential characteristic of the present invention. Accordingly, the embodiments disclosed herein are intended not to limit but to describe the technical spirit of the present invention, and the scope of the spirit of the present invention is not limited to the embodiments. The protection scope of the present invention should be interpreted by the appended claims and all the technical spirits in the equivalent range thereto are intended to be embraced by the claims of the present invention.

What is claimed is:

1. A terminal comprising:
a social group creating unit which creates a social group on a social network service;
a communication unit which transmits a search message to target terminals, configures communication connection with the target terminals by receiving a search response message which corresponds to the search message and includes a target social identifier from the target terminals, transmits an invitation message including a source social identifier and an access code to at least one target terminal which transmits the search response message among the target terminals, and receives an invitation response message corresponding to the invitation message from at least one target terminal; and
a control unit which adds at least one target terminal to the social group based on the invitation response message.

2. The terminal of claim 1, wherein the search message is a management frame used for device-to-device communication.

3. The terminal of claim 1, wherein the target social identifier includes at least one of an e-mail address, a phone number, and a subscription ID of the social network service of a user of the target terminal.

4. The terminal of claim 1, further comprising:
a storage unit which stores an identifier database.

5. The terminal of claim 4, wherein the communication unit compares the target social identifier with the identifier database and when the target social identifier exists in the identifier database, the communication unit transmits the invitation message to at least one target terminal.

6. The terminal of claim 1, wherein the control unit adds at least one target terminal to the social group when the invitation response message indicates invitation acceptance.

7. The terminal of claim 1, wherein the communication unit communicates with the server to register the social group in the server.

8. A social group configuring method of a terminal, comprising:
creating a social group on a social network service;
transmitting a search message to target terminals;
receiving a search response message corresponding to the search message and including a target social identifier from the target terminals;
transmitting an invitation message including a source social identifier and an access code to at least one target terminal which transmits the search response message among the target terminals;
receiving the invitation response message from at least one target terminal; and
adding at least one target terminal to the social group based on the invitation response message.

9. The method of claim 8, wherein the target social identifier includes at least one of an e-mail address, a phone number, and a subscription ID of the social network service of a user of the target terminal.

10. The method of claim 8, further comprising:
comparing the target social identifier with an identifier database.

11. The method of claim 10, wherein in the transmitting of the invitation message including the source social identifier and the access code to at least one target terminal which transmits the search response message among the target terminals, when the target social identifier exists in the identifier database, the invitation message is transmitted to at least one target terminal.

12. The method of claim 8, wherein in the adding of at least one target terminal to the social group based on the invitation response message, when the invitation response message indicates invitation acceptance, at least one target terminal is added to the social group.

13. The method of claim 8, further comprising:
registering the created social group in a server; and
receiving a registration identifier for the social group from the server.

14. A terminal comprising:
a communication unit which transmits a search response message including a target social identifier to a source terminal in response to a search message received from the source terminal and transmits a social group invitation response message to the source terminal in response to a social group invitation message received from the source terminal; and
a control unit which compares a source social identifier included in the social group invitation message with an identifier database to determine whether to transmit the social group invitation response message.

15. The terminal of claim 14, wherein the source social identifier includes at least one of an e-mail address, a phone number, and an ID of the social network service of a user of the source terminal.

16. The terminal of claim 15, wherein the control unit controls the communication unit to transmit the social group invitation response message when the source social identifier exists in the identifier database.

17. The terminal of claim 14, wherein the social group invitation message includes an access code for accessing the social group, and
the control unit outputs the access code so as for the user to verify the access code.
